(19) United States
(12) Patent Application Publication
(10) Pub. No.: US 2024/0330815 A1
(43) Pub. Date: Oct. 3, 2024

(54) MULTI-FEATURE RISK ANALYSIS

(71) Applicant: International Business Machines Corporation, Armonk, NY (US)

(72) Inventors: Seetha Subramaniam, Bangalore (IN); Pooja Rundwal, Bangalore (IN); Raghuraman Seshadri, Bangalore (IN); Mahesh Shivram Paradkar, Pune (IN)

(73) Assignee: International Business Machines Corporation, Armonk, NY (US)

(21) Appl. No.: 18/127,202

(22) Filed: Mar. 28, 2023

(51) Int. Cl. G06Q 10/0635

(52) U.S. Cl. CPC G06Q 10/0635

(57) ABSTRACT

An embodiment defines a risk model that generates a risk score for an asset based on a plurality of factors, including a first factor that is a first factor type and a second factor that is a second factor type. The model includes a plurality of associations, including a first association that associates a first factor weight with a specified significance of the first factor, and a second association that associates a second factor weight with a time-based metric of the second factor. The embodiment includes modifying one of the plurality of associations resulting in a modified risk model, and generating, using the modified risk model, a risk score for the asset, the generating including determining the risk score for the asset based at least in part on a first factor weight value of the first factor weight and a second factor weight value of the second factor weight.

### TECHNICAL FIELD

The present invention relates generally to a method, system, and computer program product for asset management. More particularly, the present invention relates to a method, system, and computer program product for multi-feature risk analysis.

### BACKGROUND

Risk management is the process of identifying, analyzing, and mitigating various types of risks. Within the context of asset management, risk management involves applying the risk management process to an organization's assets. An asset, as referred to herein, is a network-accessible device, such as a physical machine that has an Internet Protocol (IP) address or host name, for example as a database server or application server. Asset risk identification involves identifying and assessing threats to an organization's assets. Asset risk analysis involves determining a probability that a threat may occur and the potential outcome of such an event. Asset risk mitigation involves determining and carrying out options for reducing the vulnerability of an asset to the potential threats.

A major aspect of risk management for businesses and other institutions is the question of how information system resources should be allocated for risk identification, analysis, and mitigation. Many types of businesses or other institutions face markedly different information system threats and potential harm, and risk managers of these institutions must be able to prioritize their information systems resources based on what they anticipate being the most serious and harmful threats to their operations.

### SUMMARY

In one illustrative embodiment, a method is provided for multi-feature risk analysis. The embodiment includes defining a risk model that generates a risk score for an asset based on a plurality of factors, where the plurality of factors comprises a first factor and a second factor, where the first factor is a first factor type and the second factor is a second factor type, where the model comprises a plurality of associations, the plurality of associations comprising a first association and a second association, where the first association associates a first factor weight with a specified significance of the first factor, and the second association associates a second factor weight with a time-based metric of the second factor. The embodiment also includes modifying one of the plurality of associations resulting in a modified risk model. The embodiment further includes generating, using the modified risk model, a risk score for the asset, the generating comprising determining the risk score for the asset based at least in part on a first factor weight value of the first factor weight and a second factor weight value of the second factor weight. Other embodiments of this aspect include corresponding computer systems, apparatus, and computer programs recorded on one or more computer storage devices, each configured to perform the actions of the embodiment.

Another embodiment includes a computer usable program product. The computer usable program product includes a computer-readable storage medium, and program instructions stored on the storage medium. The program instructions, when executed on a computing device, causes the computing device to perform various ones of, and combinations of, the operations outlined above with regard to the method illustrative embodiment.

Another embodiment includes a computer system. The computer system includes a processor, a computer-readable memory, and a computer-readable storage medium, and program instructions stored on the storage medium for execution by the processor via the memory. The program instructions, when executed on a computing device, causes the computing device to perform various ones of, and combinations of, the operations outlined above with regard to the method illustrative embodiment.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example service infrastructure in accordance with an illustrative embodiment.

FIG. 3 depicts a block diagram of a system monitoring environment in accordance with an illustrative embodiment;

FIG. 4 depicts another block diagram of the system monitoring environment in accordance with an illustrative embodiment;

FIG. 5 depicts a block diagram of a threat score module in accordance with an illustrative embodiment;

FIG. 6 depicts a block diagram of a vulnerability score module in accordance with an illustrative embodiment;

FIG. 7 depicts a block diagram of a criticality score module in accordance with an illustrative embodiment;

FIG. 8 depicts a block diagram of an enforcement score module in accordance with an illustrative embodiment;

FIG. 9 depicts a block diagram of a system monitoring environment in accordance with an illustrative embodiment; and

FIG. 10 depicts a flowchart of an example process for analyzing frames of video streams to assign respective activity values in accordance with an illustrative embodiment.

### DETAILED DESCRIPTION

Proper operation of an organization's assets is essential for providing uninterrupted business services and satisfying customer expectations. Risk management is an important aspect of asset management in identifying and prioritizing the most vulnerable assets from business criticality point of view. The number of cloud computing assets in many organizations is quickly growing to, or has already surpassed, hundreds of thousands of assets, making them impractical for users to manually manage.

Organizations may adopt multiple factors to drive the determination of business criticality of an asset, and use multiple threat detection tools for detecting threats, and may adopt multiple techniques and processes in asserting the security controls posture of an asset. These techniques leave an organization with a wide verity of datasets that lack any correlation with each other. As a result, such organizations face significant difficulty when trying to properly assess/prioritize assets for better asset management.

Thus, the illustrative embodiments recognize that it is increasingly challenging to maintain and implement an asset risk management process that provides clear direction for prioritizing assets for the purpose of mitigating risks. Disclosed embodiments provide a method, system, and computer program product for prioritizing assets that processes data from various data sources that provide information related to different kinds of asset information, such as threat data, vulnerabilities data, controls data, and business criticality data. Disclosed embodiments establish a correlation between such different types of data that are measured in different ways.

For example, threat data is typically measured based on magnitude and number of occurrences over a specified period. Vulnerabilities and controls data is typically generated based on a point in time of technical assessment using tools like vulnerability scanners to detect weaknesses of assets. Business criticality data is typically measured by performing data classification and categorization of an asset using classification tools or human knowledge. Disclosed embodiments collect such various types of data and determine correlations that allow for generation of a single risk score for an asset. The risk score can then be compared to risk scores determined in the same matter for other assets to determine appropriate prioritization of such assets for risk mitigation.

In an exemplary embodiment, a computer implemented process for performing a multi-feature risk analysis generates a model driven by risk profiles comprising multiple factors and defines buckets and weights for those factors. In some embodiments, the process allows for customization and finetuning of these factors and, in response, automatically updates the associated model profiles and resulting risk analysis.

In exemplary embodiments, a risk analysis for an asset comprises calculating risk level scores for each individual threat and vulnerability, and then calculating an overall threat risk level from the individual threat risk levels and calculating an overall vulnerability risk level from the individual vulnerability risk levels.

In some embodiments, the individual threat and vulnerability risk levels are determined from the threat and vulnerabilities data associated with respective individual threats and vulnerabilities. The determining of each of the individual threat and vulnerability risk levels uses attributes that correlate the age of a threat, number of occurrences over time, snapshot of a normalized quantity (threshold value), Boolean switch, and the magnitude (criticality) of the factor to arrive at a bucket weight and the compute the threat score as TS=(Bucket Weight*factor weight). As a non-limiting example, there may be a plurality of buckets having respective bucket weights.

In this embodiment, the bucket weights that were computed are again fine-tuned by determining an addon weight. This is being done to ensure the overall score is more distinct and unique. The process calculates an addon weight by computing the percentage of increase between the actual value of an asset and the threshold bucket value, then using a slab technique to compute the addon weight to be added to the base weight. The process then determines a final score for the factor. Thus, the Threat Factor Score=Factor weight*(Bucket Base Weight+Addon Weight).

The risk level for threats are then computed by adding all threat factor scores and uses a slab technique in which the factors are categorized in various tiers based on factor weights, criticality, and detected bucket weights, and assigned appropriate risk level.

In some embodiments, the Controls and Business impact data are captured as a list of value tags. The model processes the value tags based on weights assigned to the values associated to the assets. Thus the Factor Score=Factor weight*List of value weights. The risk level is then calculated by using slab technique where in the factors are categorized in various tiers based on factor weights, tagged list of value weight.

After calculating the threat risk levels and aggregated threat risk score, Criticality risk levels and aggregated criticality risk score, vulnerability risk levels and aggregated vulnerability risk score, and enforcement risk levels and aggregated enforcement risk score, the process uses these values as threat points (TP), Criticality points (CP), vulnerability points (VP), and enforcement points (EP) to determine overall risk points (RP) representative of an overall risk for an asset.

For the calculation of RP, the model uses predetermined maximum and minimum RP values. The exact maximum and minimum RP values can vary and can be set and/or adjusted by an end user or organization. For the sake of explanation, a non-limiting example uses a maximum RP value of 800 and a minimum RP value of 300 for each asset. The model assigns weights to each of the TP, CP, VP, and EP according to respective percentages that can be set according to an organization's needs and to cater to an organization's operational efficiency. For the sake of explanation, a non-limiting example assigns weights as 40% TP; 25% CP; 15% EP; and 20% VP. The resulting RP is an indication of a level of risk, where higher RP values indicate higher levels of risk. The aim of this model is to fine tune the RP based on the characteristics of an asset and strive to compute an RP that is unique for each asset. This is achieved by applying multiple influencers in computing the RP. However, if a plurality of assets have identical characteristics from all of the above factors, the model will assign the same RP for the plurality of assets.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

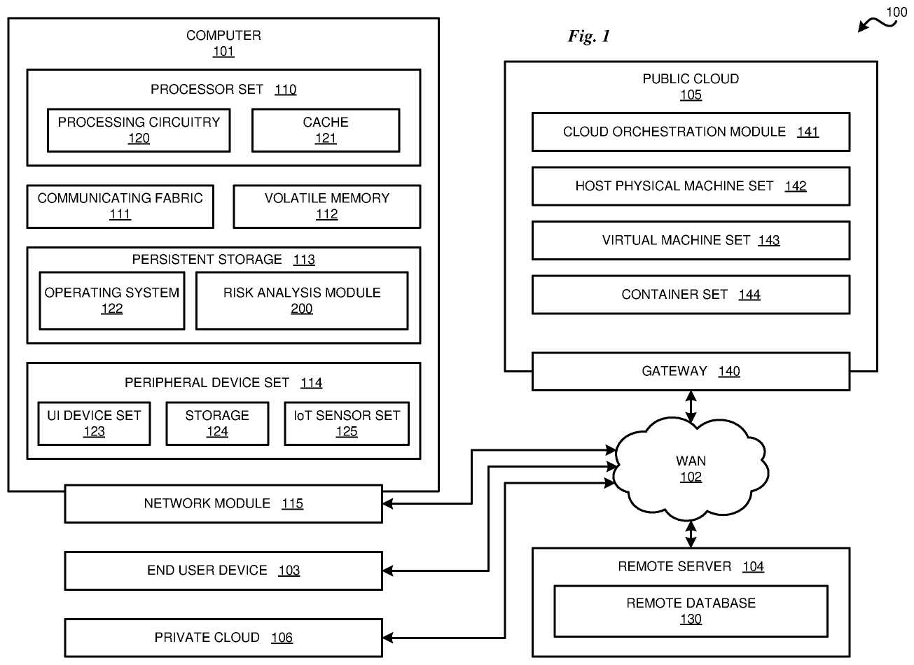

With reference to FIG. 1, this figure depicts a block diagram of a computing environment 100. Computing environment 100 contains an example of an environment for the execution of at least some of the computer code involved in performing the inventive methods, such as an improved screen sharing module risk analysis module 200 that performs multi-feature risk analysis. In addition to risk analysis module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and risk analysis module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in risk analysis module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in risk analysis module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

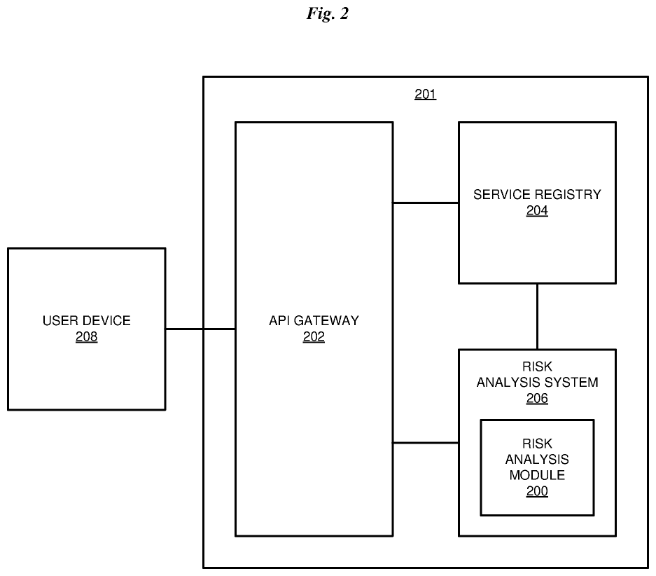

With reference to FIG. 2, this figure depicts a block diagram of an example service infrastructure 201 in accordance with an illustrative embodiment. In the illustrated embodiment, the service infrastructure 201 includes a risk analysis system 206. In an embodiment, the risk analysis system 206 is an example of the computer 101 of FIG. 1 and includes the risk analysis module 200 of FIG. 1.

In the illustrated embodiment, the service infrastructure 201 provides services and service instances to a user device 208. User device 208 communicates with service infrastructure 201 via an API gateway 202. In various embodiments, service infrastructure 201 and its associated risk analysis system 206 serve multiple users and multiple tenants. A tenant is a group of users (e.g., a company) who share a common access with specific privileges to the software instance. Service infrastructure 201 ensures that tenant specific data is isolated from other tenants.

In the illustrated embodiment, service infrastructure 201 includes a service registry 204. In some embodiments, the risk analysis system 206 is a virtual machine and the service registry 204 looks up service instances of risk analysis system 206 in response to a service lookup request such as one from API gateway 202 in response to a service request from user device 208. For example, in some embodiments, the service registry 204 looks up service instances of risk analysis system 206 in response to requests related to risk analysis from the user device 208.

In some embodiments, service registry 204 maintains information about the status or health of each service instance including performance information associated each of the service instances. In some such embodiments, such information may include various types of performance characteristics of a given service instance (e.g., cache metrics, etc.) and records of updates.

In some embodiments, user device 208 connects with API gateway 202 via any suitable network or combination of networks such as the Internet, etc. and uses any suitable communication protocols such as Wi-Fi, Bluetooth, etc. Service infrastructure 201 may be built based on cloud computing. API gateway 202 provides access to client applications like the risk analysis module 200. API gateway 202 receives service requests issued by client applications and creates service lookup requests based on service requests. As a non-limiting example, in an embodiment, the user device 208 executes a routine to initiate interaction with the risk analysis module 200. For instance, in some embodiments, the user accesses the risk analysis module 200 directly using a command line or GUI. Also, in some embodiments, the user accesses the risk analysis module 200 indirectly using a web application that interacts with the risk analysis module 200 via the API gateway 202.

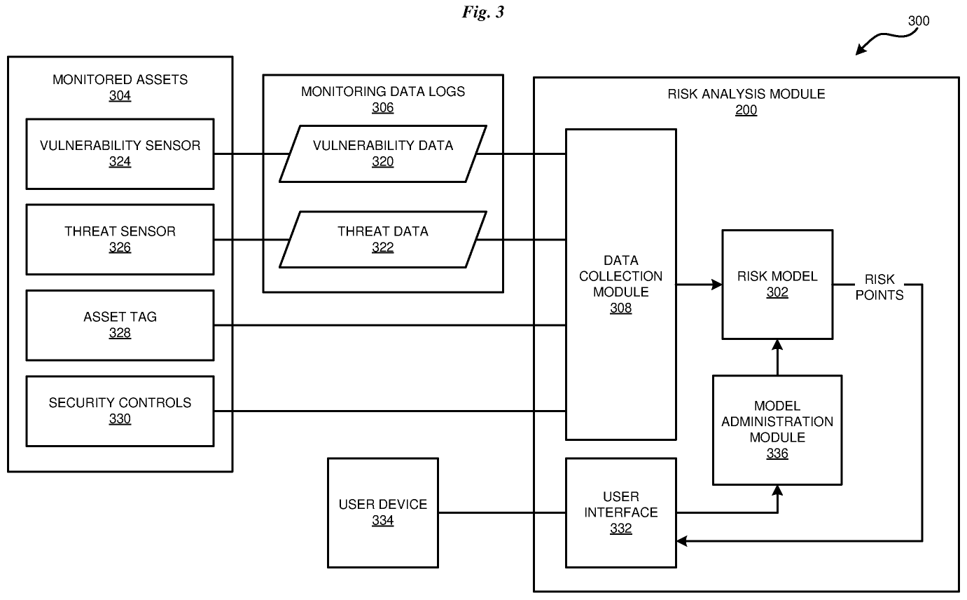

With reference to FIG. 3, this figure depicts a block diagram of a system monitoring environment 300 in accordance with an illustrative embodiment. In the illustrated embodiment, the system monitoring environment 300 includes a risk analysis module 200 of the computer 101 of FIG. 1.

In the illustrated embodiment, the risk analysis module 200 includes a data collection module 308, a risk model 302, a user interface 332, and a model administration module 336. In alternative embodiments, the risk analysis module 200 can include some or all the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the risk analysis module 200 receives data from various data sources that provide information related to different kinds of asset information, such as threat data, vulnerabilities data, controls data, and business criticality data. The risk analysis module 200 establishes a correlation between such different types of data that allows for generation of a single risk score for an asset. The risk score can then be compared to such risk scores of other assets to determine appropriate prioritization of such assets for risk mitigation.

In the illustrated embodiment, the data collection module 308 of the risk analysis module 200 receives vulnerability data 320 and threat data 322 from monitoring data logs 306. The monitoring data logs 306 include vulnerability data 320 from a vulnerability sensor 324 and threat data 322 from a threat sensor 326 from each of a plurality of monitored assets 304. The data collection module 308 also receives criticality data from an asset tag 328 and enforcement data from security controls 330 from each of the plurality of monitored assets 304.

The data collection module 308 provides the collected data to a risk model 302 on an asset-by-asset basis. The risk model 302 generates risk points for each of the monitored assets 304 such that the risk points serve as risk scores for respective monitored assets 304. The risk points/risk scores are provided to a user interface 332 where they can be output to a user device 334.

In addition to outputting risk scores for the monitored assets 304 to the user device 334, the user interface 332 also allows a user using the 334 to make changes to the risk model 302 via the model administration module 336. For example, in some embodiments, the risk model 302 may process business context information, for example related to the criticality of one or more of the monitored assets 304, so an organization can define its own way of judging the criticality of the monitored assets 304 and/or use customized weights that allow the organization to configure the risk model 302 for any desired scale of values.

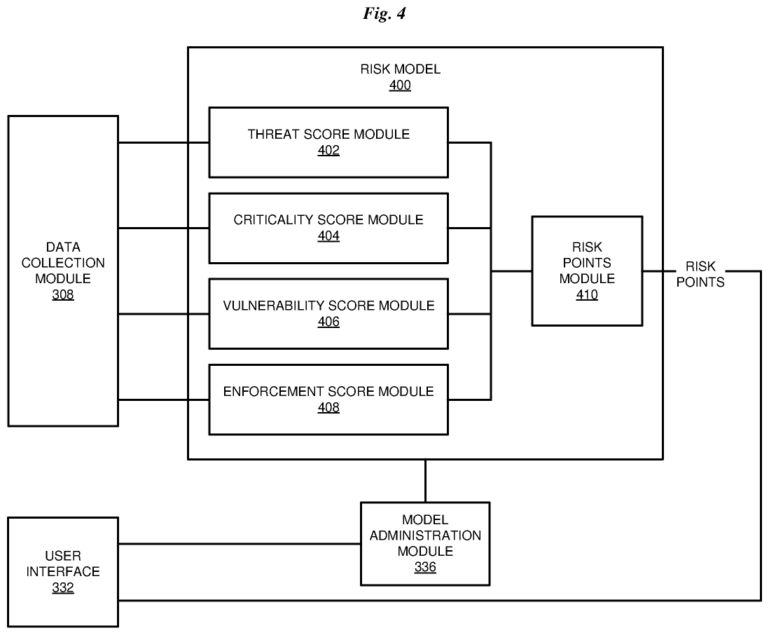

With reference to FIG. 4, this figure depicts another block diagram of the system monitoring environment 300 in accordance with an illustrative embodiment. In the illustrated embodiment, the system monitoring environment 300 includes a risk model 400 as an example of the risk model 302 of FIG. 3.

In the illustrated embodiment, the risk model 400 includes a threat score module 402, a criticality score module 404, a vulnerability score module 406, an enforcement score module 408, and a risk points module 410. In alternative embodiments, the risk model 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the risk model 400 receives data from the data collection module 308, which has collected data from various different data sources that provide information related to different kinds of asset information, such as threat data, vulnerabilities data, controls data, and business criticality data. The data collection module 308 provides the collected data to the risk model 400 on an asset by asset basis. The threat score module 402 receives the threat data, the criticality score module 404 receives the criticality data, the vulnerability score module 406 receives the vulnerability data, and the enforcement score module 408 receives the controls data. The threat score module 402, criticality score module 404, vulnerability score module 406, and enforcement score module 408 generate respective scores and risk level that are provided to the risk points module 410. The risk points module 410 establishes a correlation between the different received scores and generates a single risk score for an asset. The risk score can then be compared to such risk scores of other assets to determine appropriate prioritization of such assets for risk mitigation.

The risk points/risk scores along with Risk level are provided to a user interface 332 where they can be output to a user device (e.g., user device 334 of FIG. 3). In addition to outputting risk scores for the monitored assets 304 to the user device 334, the user interface 332 also allows a user using the 334 to make changes to the risk model 302 via the model administration module 336.

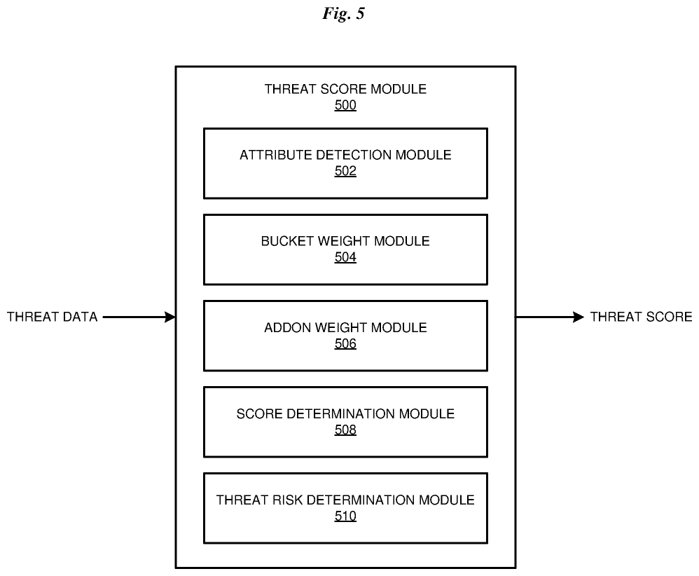

With reference to FIG. 5, this figure depicts a block diagram of a threat score module 500 in accordance with an illustrative embodiment. In the illustrated embodiment, the threat score module 500 is an example of the threat score module 402 of FIG. 4.

In the illustrated embodiment, the threat score module 500 includes an attribute detection module 502, a bucket weight module 504, an addon weight module 506, a score determination module block 508, and a threat risk determination module 510. In alternative embodiments, the threat score module 500 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The threat score module 500 calculates threat scores for each threat that occurs within a specified period. A threat is an event that can have negative consequences on an asset, such as anomalies, exceptions, and offenses. The attribute detection module 502 extracts attributes of each threat that will be used to determine threat scores. In some embodiments, the attribute detection module 502 extracts an age, a quantity, and a magnitude (severity) of the threat. The bucket weight module 504 correlates these dimensions to identify a bucket based on a respective threshold value. For example, in an embodiment, a model for the attribute detection module 502 includes buckets that have respective bucket weights, and each bucket is associated with a respective time metric and threshold count. As a non-limiting example, there may be a plurality of buckets as shown in Table 1.

TABLE 1

| | | Bucket: Highly Likely | Bucket: Possible | Bucket: Likely |
|---|---|---|---|---|
| | | Criticality: Critical | Criticality: High, Major | Criticality; Minor |
| | | Seen in last 7 days. | Seen in last 15 days. | Seen in last 28 days. |
| F | W | Threshold Count: 5 | Threshold Count: 15 | Threshold Count: 30 |
| anomalies | 8 | 8 | 6 | 4 |
| exceptions | 10 | 8 | 6 | 4 |
| offences | 4 | 8 | 6 | 4 |

The addon weight module 506 then calculates an addon weight by computing the percentage of increase between the actual value of an asset and the threshold bucket value, then uses a slab technique to compute the addon weight to be added to the base weight. The score determination module 508 then calculates a score for each threat as Threat Score=Factor weight*(Bucket Base Weight+Addon Weight). Once a threat score has been determined for each threat, the threat risk determination module block 510 calculates a final threat score for an asset as a sum of all threat scores. Threat Risk level is calculated by using the slab technique wherein the factors are categorized in various tiers based on factor weights, tagged list of value weight.

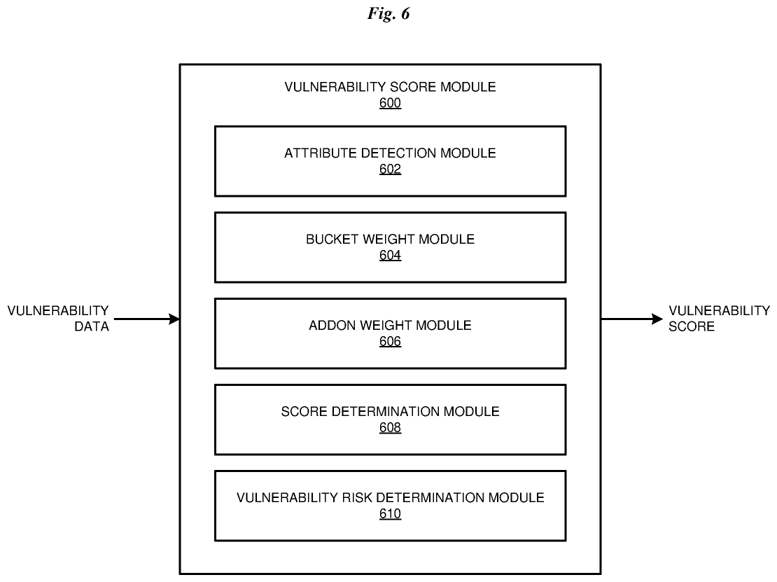

With reference to FIG. 6, this figure depicts a block diagram of a vulnerability score module 600 in accordance with an illustrative embodiment. In the illustrated embodiment, the vulnerability score module 600 is an example of the vulnerability score module 406 of FIG. 4.

In the illustrated embodiment, the vulnerability score module 600 includes an attribute detection module 602, a bucket weight module 604, an addon weight module 606, a score determination module 608, and vulnerability risk determination module 610. In alternative embodiments, the vulnerability score module 600 can include some or all the functionalities described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The vulnerability score module 600 calculates vulnerability scores for each vulnerability that occurs within a specified period. Vulnerabilities are point in time technical assessments using tools like vulnerability scanners to detect weakness of the assets. The attribute detection module 602 extracts attributes of each vulnerability that will be used to determine vulnerability scores. In some embodiments, the attribute detection module 602 extracts an age, quantity, and a magnitude (severity) of the vulnerability. The bucket weight module 604 correlates these dimensions to identify a bucket based on a respective threshold value. For example, in an embodiment, a model for the attribute detection module 602 includes buckets that have respective bucket weights, and each bucket is associated with a respective time metric and threshold count. As a non-limiting example, there may be a plurality of buckets as shown in Table 1 above.

The addon weight module 606 then calculates an addon weight by computing the percentage of increase between the actual value of an asset and the threshold bucket value, then using a slab technique to compute the addon weight to be added to the base weight. The score determination module 608 then calculates a score for each vulnerability as a Vulnerability Score=Factor weight*(Bucket Base Weight+Addon Weight). Once a vulnerability score has been determined for each vulnerability, the vulnerability risk determination module 610 calculates a final vulnerability score for an asset as a sum of all vulnerability scores.

The Vulnerability Risk determination module 610 calculates the final Vulnerability Risk level. Vulnerability Risk level is calculated by using the slab technique wherein the factors are categorized in various tiers based on factor weights, tagged list of value weight

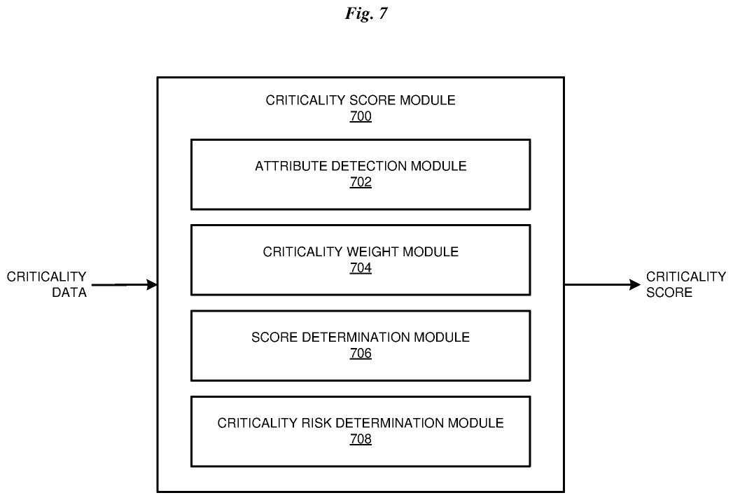

With reference to FIG. 7, this figure depicts a block diagram of a criticality score module 700 in accordance with an illustrative embodiment. In the illustrated embodiment, the criticality score module 700 is an example of the criticality score module 404 of FIG. 4.

In the illustrated embodiment, the criticality score module 700 includes an attribute detection module 702, a criticality weight module 704, a score determination module 706 and criticality risk determination module 708. In alternative embodiments, the criticality score module 700 can include some or all the functionalities described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The criticality score module 700 calculates a criticality score for each asset. A criticality is a business context of an asset that describes a level of importance an asset is to an organization. The attribute detection module 702 extracts attributes of each criticality that will be used to determine criticality scores. In some embodiments, the attribute detection module 702 extracts a criticality factor of the criticality.

The criticality weight module 704 determines a criticality weight according to a fixed association in the model that associates each criticality value with a respective criticality weight. The score determination module 706 then calculates a score for the asset as Criticality Factor Score=Factor weight*List of value weights. The Risk determination module 708 calculates the final Criticality Risk level. Criticality Risk level is calculated by using the slab technique wherein the factors are categorized in various tiers based on factor weights, and a tagged list of value weights.

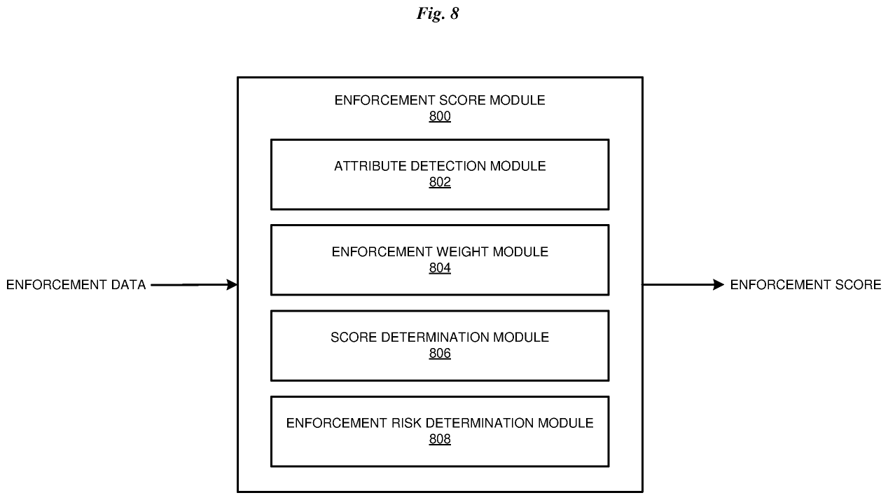

With reference to FIG. 8, this figure depicts a block diagram of an enforcement score module 800 in accordance with an illustrative embodiment. In the illustrated embodiment, the enforcement score module 800 is an example of the enforcement score module 408 of FIG. 4.

In the illustrated embodiment, the enforcement score module 800 includes an attribute detection module 802, an enforcement weight module 804, a score determination module 806 and an enforcement risk determination module 808. In alternative embodiments, the enforcement score module 800 can include some or all the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The enforcement score module 800 calculates enforcement scores for each asset. An enforcement is a factor type of an asset that describes a security control of an asset. Security controls are parameters implemented to protect various forms of data and infrastructure important to an organization. Any type of safeguard or countermeasure used to avoid, detect, counteract, or minimize security risks to an asset is considered a security control. The attribute detection module 802 extracts attributes of each enforcement that will be used to determine enforcement scores. In some embodiments, the attribute detection module 802 extracts a security control for the asset.

The enforcement weight module 804 determines an enforcement weight according to a fixed association in the model that associates each enforcement value with a respective enforcement weight. The score determination module 806 then calculates a score for the asset as Enforcement Factor Score=Factor weight*List of value weight. The Enforcement Risk determination module 810 calculates the final Enforcement Risk level. Enforcement Risk level is calculated by using the slab technique wherein the factors are categorized in various tiers based on factor weights, tagged list of value weights.

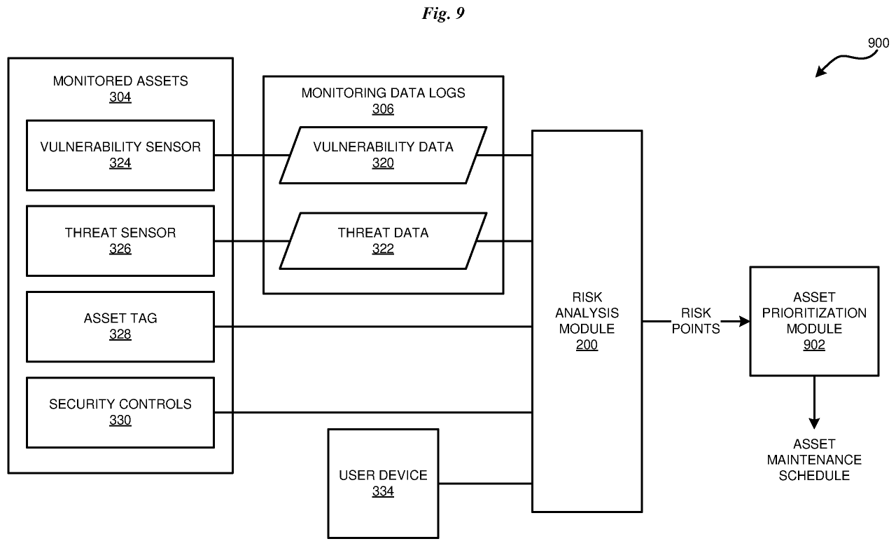

With reference to FIG. 9, this figure depicts a block diagram of a system monitoring environment 900 in accordance with an illustrative embodiment. In the illustrated embodiment, the system monitoring environment 900 includes a risk analysis module 200 of the computer 101 of FIG. 1. The system monitoring environment 900 is similar to the system monitoring environment 300 of FIG. 3 except for the differences described below, so the description of the system monitoring environment 300 applies equally to the system monitoring environment 900 of FIG. 9.

In the illustrated embodiment, the risk model 302 generates risk points for each of the monitored assets 304 such that the risk points serve as risk scores for respective monitored assets 304. The risk points/risk scores are provided to an asset prioritization module 902 that organizes the monitored assets 304 into an ordered list according to risk scores. For example, in some embodiments, the asset prioritization module 902 generates an ordered list of the monitored assets 304 from highest risk score to lowest risk score such that the monitored assets 304 are provided in a list that prioritizes the assets according to respective risk scores. In some embodiments, the asset prioritization module 902 uses the ordered list to generate an asset maintenance schedule that also prioritizes the maintenance of the assets according to respective risk scores.

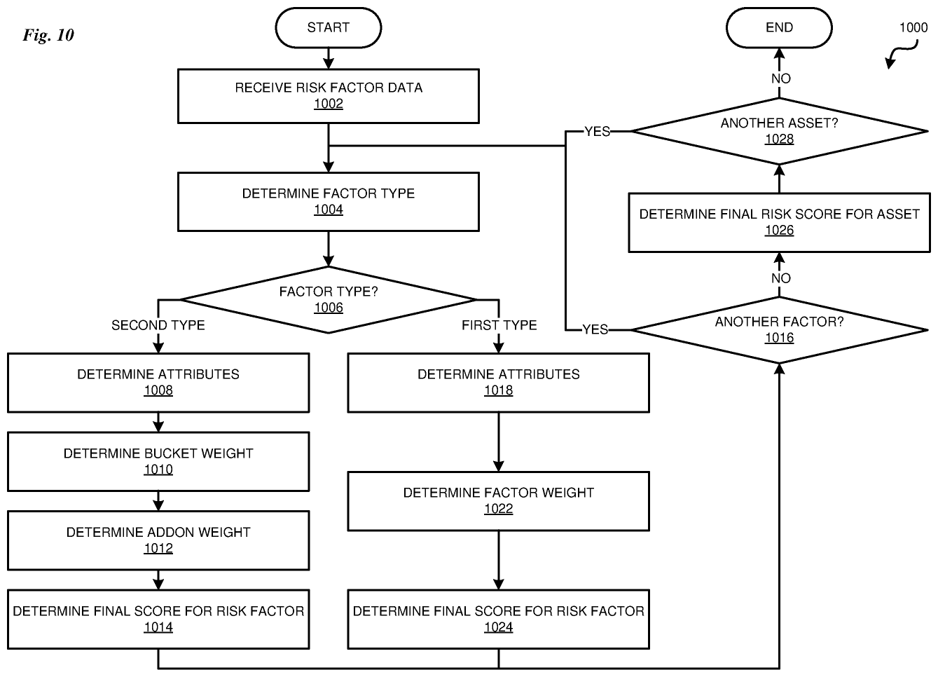

With reference to FIG. 10, this figure depicts a flowchart of an example process 1000 for multi-feature risk analysis in accordance with an illustrative embodiment. In a particular embodiment, the risk analysis module 200 of FIGS. 1-3 and 9 carries out the process 1000.

At block 1002, the process receives risk factor data for one or more assets. At block 1004, the process determines a factor type of a first factor of a first asset, and works through the factors as the process performs subsequent loops. Next, at block 1006, the process continues to block 1008 if the factor type is a Vulnerability/Threat type, or continues to block 1018 if the factor type is an Enforcement/Criticality type.

At block 1008, the process determines attributes. In some embodiments, the process extracts attributes of each factor that will be used to determine a score for each factor. In some embodiments, the attributes include an age, a quantity, and a magnitude (severity) of the factor.

Next, at block 1010, the process determines a bucket weight. In some embodiments, the process correlates the attributes determined at block 1008 to identify a bucket based on a respective threshold value. For example, in an embodiment, a model for the process includes buckets that have respective bucket weights, and each bucket is associated with a respective time metric and threshold count. As a non-limiting example, there may be a plurality of buckets as shown in Table 1 above.

Next, at block 1012, the process determines an addon weight. In some embodiments, the process calculates an addon weight by computing the percentage of increase between the actual value of an asset and the threshold bucket value, then using a slab technique to compute the addon weight to be added to the base weight.

Next, at block 1014, the process determines a final score for the risk factor. In some embodiments, the process calculates a score for each factor as a Factor Score=Factor weight*(Bucket Base Weight+Addon Weight).

Next, at block 1016, the process determines if there is another factor for the present asset. If so, the process returns to block 1004. Otherwise, the process continues to block 1026.

At block 1006, the process continues to block 1018 if the factor type is Criticality/Enforcement type.

Next, at block 1018, the process determines attributes associated with respective Criticality/Enforcement aspects of each asset. In some embodiments, the process extracts attributes of each enforcement that will be used to determine enforcement scores.

Next, at block 1022, the process determines factor weight. In some embodiments, the process determines a factor weight according to a fixed association in the model that associates each factor with a respective factor weight. Next, at block 1024, the process determines a final score for a risk factor. In some embodiments, the process then calculates a score for the asset as Enforcement Factor Score=Factor weight*List of value weight.

A block 1026, the process determines final risk score for each asset. In some embodiments, the final risk score is a sum of the threat points/score (TP), enforcement points/score (EP), vulnerability points/score (VP), and criticality points/score (CP). In some embodiments, the contributions of each of the scores to the final asset risk score are distributed by default based on fixed percentages, for example: 40% TP; 25% CP; 15% EP; and 20% VP. In some embodiments, the fixed percentages can be adjusted based on operational efficiency.

Next, at block 1028, the process determines if there is another asset to evaluate. If so, the process returns to block 1004. Otherwise, the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
defining a risk model that generates a risk score for an asset based on a plurality of factors,
wherein the plurality of factors comprises a first factor and a second factor, wherein the first factor is a first factor type and the second factor is a second factor type,
wherein the model comprises a plurality of associations, the plurality of associations comprising a first association and a second association,
wherein the first association associates a first factor weight with a specified significance of the first factor, and
wherein the second association associates a second factor weight with a time-based metric of the second factor,
modifying one of the plurality of associations resulting in a modified risk model; and
generating, using the modified risk model, a risk score for the asset, the generating comprising determining the risk score for the asset based at least in part on a first factor weight value of the first factor weight and a second factor weight value of the second factor weight.

2. The computer implemented method of claim 1, the generating of the risk score further comprising:
retrieving first factor data from an event log of the specified asset, wherein the first factor data is representative of the first factor of the specified asset; and
identifying a weight value of the first factor weight associated with the specified asset.

3. The computer implemented method of claim 2, the generating of the risk score further comprising:
retrieving second factor data from an asset tag of the specified asset, wherein the second factor data is representative of the second factor of the specified asset; and
identifying the second factor weight value of the second factor weight associated with the specified asset.

4. The computer implemented method of claim 1, wherein the specified significance is based at least in part on a tag value of an asset tag associated with the asset, wherein the first factor weight value is based at least in part on a tag weight value associated with the tag value, and
wherein the modifying of one of the plurality of associations comprises changing the first association by changing the tag weight value associated with the tag value.

5. The computer implemented method of claim 1, wherein the time-based metric is based at least in part on a number of occurrences during the specified window of time, wherein the second factor weight value is based at least in part on a bucket weight value associated with a range of numbers of occurrences; and
wherein the modifying of one of the plurality of associations comprises changing the second association by changing the range of numbers of occurrences associated with the bucket weight value.

6. The computer implemented method of claim 1, wherein the first factor is a criticality factor type that is assigned a criticality tag value, wherein the first factor weight value is based at least in part on a criticality tag weight value associated with the criticality tag value.

7. The computer implemented method of claim 6, further comprising determining a criticality score for the first factor based at least in part on a product of the first factor weight value and a criticality weight associated with the criticality type.

8. The computer implemented method of claim 1, wherein the second factor is a threat factor type that is associated with a threat factor weight and threat bucket weight, wherein the second association associates the threat factor with the threat bucket weight based at least in part on the time-based metric, wherein the time-based metric comprises a number of occurrences during the specified window of time.

9. The computer implemented method of claim 8, further comprising determining a threat score based at least in part on a product of the threat bucket weight and the threat factor weight.

10. The computer implemented method of claim 1, wherein the second factor is a vulnerability factor type that is associated with a vulnerability factor weight and vulnerability bucket weight, wherein the second association associates the vulnerability factor with the vulnerability bucket weight based at least in part on the time-based metric, wherein the time-based metric comprises a number of occurrences during the specified window of time.

11. The computer implemented method of claim 10, further comprising determining a vulnerability score based at least in part on a product of the vulnerability bucket weight and the vulnerability factor weight.

12. The computer implemented method of claim 1, wherein first factor is an enforcement factor type that is assigned an enforcement tag value, wherein the first factor weight value is based at least in part on an enforcement tag weight value associated with the enforcement tag value.

13. The computer implemented method of claim 12, further comprising determining an enforcement score for the first factor based at least in part on a product of the first factor weight value and an enforcement weight associated with the enforcement type.

14. The computer implemented method of claim 1, wherein the risk score is based at least in part on a criticality factor, a threat factor, a vulnerability factor, and an enforcement factor.

15. A computer program product for cognitive categorization of digital assets, the computer program product comprising a computer readable storage medium having program instructions embodied therewith, the program instructions executable by a processor to cause the processor to perform operations comprising:
defining a risk model that generates a risk score for an asset based on a plurality of factors,
wherein the plurality of factors comprises a first factor and a second factor, wherein the first factor is a first factor type and the second factor is a second factor type,
wherein the model comprises a plurality of associations, the plurality of associations comprising a first association and a second association,
wherein the first association associates a first factor weight with a specified significance of the first factor, and
wherein the second association associates a second factor weight with a time-based metric of the second factor,
modifying one of the plurality of associations resulting in a modified risk model; and
generating, using the modified risk model, a risk score for the asset, the generating comprising determining the risk score for the asset based at least in part on a first factor weight value of the first factor weight and a second factor weight value of the second factor weight.

16. The computer program product of claim 15, wherein the stored program instructions are stored in a computer readable medium in a data processing system, and wherein the stored program instructions are transferred over a network from a remote data processing system.

17. The computer program product of claim 15, wherein the stored program instructions are stored in a computer readable medium in a server data processing system, and wherein the stored program instructions are downloaded over a network to a remote data processing system for use in a computer readable medium associated with the remote data processing system, further comprising:
program instructions to meter use of the computer usable code associated with the request; and
program instructions to generate an invoice based on the metered use.

18. The computer program product of claim 15, wherein the risk score is based at least in part on a criticality factor, a threat factor, a vulnerability factor, and an enforcement factor.

19. A computer system comprising a processor and one or more computer readable storage media, and program instructions collectively stored on the one or more computer readable storage media, the program instructions executable by the processor to cause the processor to perform operations comprising:
defining a risk model that generates a risk score for an asset based on a plurality of factors,
wherein the plurality of factors comprises a first factor and a second factor, wherein the first factor is a first factor type and the second factor is a second factor type,
wherein the model comprises a plurality of associations, the plurality of associations comprising a first association and a second association,
wherein the first association associates a first factor weight with a specified significance of the first factor, and
wherein the second association associates a second factor weight with a time-based metric of the second factor,
modifying one of the plurality of associations resulting in a modified risk model; and
generating, using the modified risk model, a risk score for the asset, the generating comprising determining the risk score for the asset based at least in part on a first factor weight value of the first factor weight and a second factor weight value of the second factor weight.

20. The computer program product of claim 15, wherein the risk score is based at least in part on a criticality factor, a threat factor, a vulnerability factor, and an enforcement factor.
